(19) United States
(12) Patent Application Publication
(10) Pub. No.: US 2005/0183120 A1
(43) Pub. Date: Aug. 18, 2005

(54) Multi-user personalized digital multimedia distribution methods and systems

(76) Inventors: Saurabh Jain, Saratoga, CA (US); Shanker Iyer, San Jose, CA (US); Satish Kowkuntla, Santa Clara, CA (US); Mahadevan Iyer, Saratoga, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/034,124

(22) Filed: Jan. 12, 2005

Related U.S. Application Data
(60) Provisional application No. 60/536,326, filed on Jan. 13, 2004.

(51) Int. Cl. H04N 7/173; G06F 13/00; H04N 5/445; G06F 3/00

(52) U.S. Cl. 725/46; 725/86; 725/61; 725/93

(57) ABSTRACT

A media distribution technique employs a multi-user server positioned at the terminal end of a broadcast media network. The server receives broadcast media signals and selectively captures a portion of the signals for live personalized media streaming and/or storage for later personalized media streaming and/or download over a local distribution network to a collection of user receivers. Request/control streams sent from the receivers to the server control real-time personalization of the media streams such as trick-play functions and channel selection. Buffering and data storage segmentation techniques are used to provide highly responsive personal video recorder-like functionality to the multiple end users.

### CROSS-REFERENCE TO RELATED APPLICATIONS

This application claims priority from U.S. provisional patent application No. 60/536326 filed Jan. 13, 2004, which is incorporated herein by reference.

### FIELD OF THE INVENTION

The present invention relates generally to the field of digital media distribution systems and methods including, for example, techniques for delivering personalized live and time-shifted media streams to multiple users.

### BACKGROUND OF THE INVENTION

There exist systems and devices today that implement the ability to personalize and/or make more interactive the traditional broadcast media content through the use of digital audio/video recording and playback hardware and software. The two typical implementations of this functionality are with equipment deployed at the head-end or the user-end of the distribution network.

As shown in FIG. 1A, a familiar user-end implementation has N receivers 100 at the user-end, each equipped with a Personal Video Recorder (PVR) within or as an adjunct to a home digital set-top box. Each receiver typically tunes to a user-specified channel selected from among M broadcast media signals 102 being delivered to the receivers over a broadcast media network 104 from a collection of broadcast transmitters 106. Typical networks 104 use a Hybrid Fiber Coax (HFC) cable or satellite Digital Broadcast Satellite (DBS) network for transmitting the media streams. Each of the N receivers 100 decodes and records the content on its selected channel, allowing the content to be played back at a later time. The end-user is presented with a user interface to the receiver's PVR whereby they are able to select what broadcast channels should be recorded and when. Additionally, the user interface typically gives the end-user the ability to request functions such as pause, play, stop, rewind, fast forward—collectively referred to as trick-play-for both the recorded programming and the live broadcast channels. While some of the receiver devices have provisions for multiple members of the household to set up their separate preferences on the device, these receiver devices are essentially designed for use by a single endpoint user of a cable or satellite distribution network.

As shown in FIG. 1B, in a head-end based (or network-based) implementation N receivers 110 at the user end of a media network 114 are basic set-top boxes with no PVR. Instead, transmitters 116 at the head-end are equipped with Video-on-Demand (VoD) servers that have large amounts of stored media. The transmitters 116 are capable of originating M broadcast streams plus N VoD media streams 112. Because the VoD servers are located at the head-end of the network 114, they must rely on a carefully co-coordinated implementation of supporting features in various downstream distribution network elements which leads to increased costs and complexity.

It is significant to note that neither of the above-described implementations distinguishes between or makes any accommodations for the differences between a single-user (e.g., a typical home subscriber viewing environment) and a multi-user collection (e.g., typical commercial viewing environments such as restaurants, offices, multi-dwelling units (MDUs), multi-tenant units (MTUs), hotels, hospitals, shopping malls, or households with multiple TVs). Consequently, these implementations present significant problems when analyzed in the context of multi-user scenarios. For example, the home PVR approach, while very feature rich for the end user, requires the equivalent of an expensive set-top box with its own storage device for every individual user, hotel room, or apartment. The network-based approach, on the other hand, can not treat multi-user viewing environments any different than multiple single-user environments, and it is therefore unable to provide any cost or complexity savings. Supporting each of the users with a network-based approach amounts to the broadcast network being provisioned to carry an additional personalized channel for each user.

In view of the above, there is a need for a better solution to provide PVR functionality in multi-user viewing environments.

### SUMMARY OF THE INVENTION

In one aspect, the present invention provides a multi-user personalized multimedia distribution method in which a plurality of media signals are broadcast over a media broadcast network from a plurality of network transmitters located at a head end of the media broadcast network. At a multi-user media server located at a terminal point of the media broadcast network the plurality of media signals are received and stored. The server generates from the plurality of media signals a plurality of corresponding personalized unicast media streams independently customized using a plurality of stored personalization preferences and transmits the plurality of personalized media streams over a media stream distribution network to a corresponding plurality of end user devices associated with the stored personalization preferences.

The multi-user media server may selectively record live broadcast channels as determined by the plurality of stored personalization preferences or as determined by system administrator control signals transmitted from a remote location to the multi-user media server. The stored personalization preferences may be specified at least in part by an end user and/or by a system operator.

The end user device may be provided with a user interface presenting user options for controlling and customizing a corresponding unicast media stream. The end user device generates a media control stream in response to a selected user option and transmits the media control stream from the end user device to the multi-user media server. The media control stream may contain, for example, trick-play requests. In response to such requests, the server introduces a media time shift operations on the corresponding unicast media streams to implement the trick-play requests in the control stream. The media control stream may be implemented, for example, using RTSP or a variant thereof.

The server may segment each of the received media signals into separate media chunks, time-tag each media chunk with a unique time tag identifying a start time of the media chunk, and store the separate media chunks. The chunk size may be selected based on an indexing capacity of a storage device used to store the media chunks (e.g., a distributed data storage system). In some cases, the media signals are encoded media signals and the segmenting is performed without decoding the encoded media signals. A media chunk index may be used when storing and retrieving the chunks.

The method may include techniques such as generating at an end user device a request for a fresh stream from the multi-user media server in response to an empty stream buffer state lasting longer than a predetermined minimum threshold. Another technique involves restarting a unicast stream and resetting a media start time at the multi-user media server in response to a gap in a media signal lasting longer than a predetermined threshold. The method may also include generating at the multi-user media server a fresh unicast stream in response to a request by an end user device, wherein the fresh stream comprises an additional buffer portion of the media stream. Another technique which may be used is generating a the multi-user media server an initial unicast media stream burst in response to receiving a request from an end user to change media channels or in response to receiving a trick-play control request from an end user.

In another aspect, the method may include transmitting over a back-end peer-to-peer network layer an on-demand media signal from a network transmitter located at a head end of the media network. More generally, media signals may include various types of media such as broadcast media, on-demand prerecorded media, advertisements, video blogs, audiovisual media, and audio media. The media broadcast network may be, for example, a cable media network, a satellite media network, a wireless television broadcast network, or a video storage playback device. The media stream distribution network may be, for example, an IP network, a wifi network, or a two-way enabled multi-dwelling unit cable plant. The personalized media streams may be transported over such a network using various techniques such as embedding the media streams in RTP packets and transmitting the RTP packets using TCP/IP. The end user devices receiving the personalized streams may be any of various kinds of suitable devices such as a desktop computer, a laptop computer, a hand-held computer, or a set-top box coupled with a television.

In another aspect, the media signals received at the multi-user media server may be encrypted for secure storage, and, similarly, the personalized unicast media streams may be encrypted, e.g., using an encryption key specific to each unicast media stream. A management server in secure communication with multiple multi-user media servers may provide one of the multi-user media servers with one or more media encryption keys. The management server may also perform an authorization check to authorize a user device to receive a specified media content. A network map of multiple multi-user media servers may be stored at the management server, which uses the map to assign user devices to multi-user media servers. The management server may also transparently connect a user device to a multi-user media server capable of delivering a unicast stream to the user device at a required quality level.

In another aspect, a multi-user personalized multimedia distribution system is provided. The system includes a media broadcast network, a plurality of network transmitters located at a head end of the media broadcast network, a multi-user media server located at a terminal point of the media broadcast network, a media stream distribution network connected to the multi-user media server, and a plurality of end user devices connected to the media stream distribution network. The multi-user media server has an input processor for receiving from the media broadcast network a plurality of media signals transmitted from the plurality of network transmitters, a storage device for storing the plurality of media signals, a streaming module for generating from the plurality of media signals a plurality of corresponding personalized unicast media streams independently customized using a plurality of stored personalization preferences, and an output processor for transmitting the personalized unicast streams over the media stream distribution network to the plurality of end user devices.

At least one of the end user devices may have a user interface presenting user options for controlling and customizing a corresponding unicast media stream, and a network interface for transmitting from the end user device to the multi-user media server a media control stream in response to a selected user option.

The multi-user media server may have a segmentation module for segmenting each of the media signals into separate media chunks and time-tagging each media chunk with a unique time tag identifying a start time of the media chunk, and wherein the storage device stores the media signals in the form of separate media chunks whose size may be selected based on an indexing capacity of the storage device. The storage device may be a distributed data storage system.

The media broadcast network may be, for example, a cable media network, a satellite media network, a wireless television broadcast network, or a video storage playback device. The media stream distribution network may be, for example, an IP network, a wifi network, or a two-way enabled multi-dwelling unit cable plant. The end user device may be, for example, a desktop computer, a laptop computer, a hand-held computer, or a set-top box coupled with a television.

The multi-user media server may have an encoder for encrypting the media signals prior to storage. An authorization server may be provided in the system for performing an authorization check to authorize a user device to receive a specified media content from the multi-user media server. The system may have a management server in secure communication with multiple multi-user media servers, providing each multi-user media server with one or more media encryption keys. The management server may also maintain a network map of multiple multi-user media servers and assign user devices to multi-user media servers. The management server in some cases may transparently connect a user device to a multi-user media server capable of delivering a unicast stream to the user device at a required quality level.

In another aspect, a multi-user media server is provided. The server has an input processor for receiving from a media broadcast network a plurality of media signals transmitted from a plurality of network transmitters, a storage device for storing the plurality of media signals, a streaming module for generating from the plurality of media signals a plurality of corresponding personalized unicast media streams independently customized using a plurality of stored personalization preferences, and an output processor for transmitting the personalized unicast streams over a media stream distribution network to a plurality of end user devices.

The input processor may selectively receive live broadcast channels as determined by the plurality of stored personalization preferences, or as determined by system administrator control signals transmitted from a remote location to the multi-user media server. The stored personalization preferences may be specified at least in part by an end user or by a system operator.

These and other aspects of the invention will now be described in detail with reference to the drawing figures.

### BRIEF DESCRIPTION OF THE DRAWINGS

FIG. 1A illustrates a conventional user-end PVR media distribution system.

FIG. 1B illustrates a conventional head-end VoD media distribution system.

FIG. 2A illustrates a first embodiment of a media distribution system according to the present invention.

FIG. 2B illustrates an alternative embodiment of a media distribution system according to the present invention.

FIG. 3 illustrates an embodiment of the present invention wherein media captured by a PVR server and media distributed from the PVR server may be in the form of either streamed media or downloaded media files.

FIG. 4 illustrates an embodiment of the invention wherein the multi-user PVR distributes streaming media using IP over RF cable in an MDU/MTU environment.

FIG. 5 illustrates an end-user receiver device according to one embodiment of the present invention.

FIG. 6 illustrates a multi-user PVR server according to a preferred embodiment of the present invention.

FIG. 7 illustrates an embodiment of the present invention wherein an authorization/license server provides a PVR server and/or receivers with a license and/or media encryption key.

FIG. 8 illustrates aspects of a PVR server according to one embodiment of the present invention.

FIG. 9 illustrates an embodiment of the present invention wherein a multi-user PVR server uses admission control to decide if the distribution network has required resources.

FIG. 10 illustrates an embodiment of the present invention wherein a management server is used to control and manage several multi-user PVR systems.

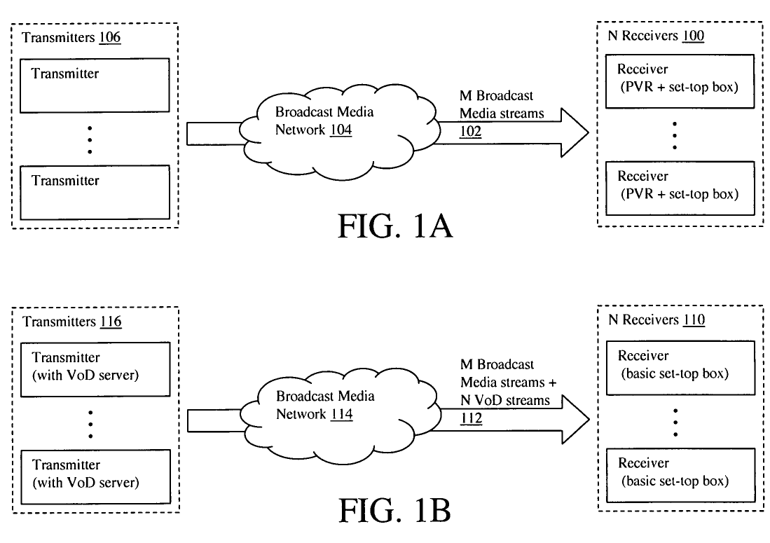

### DETAILED DESCRIPTION

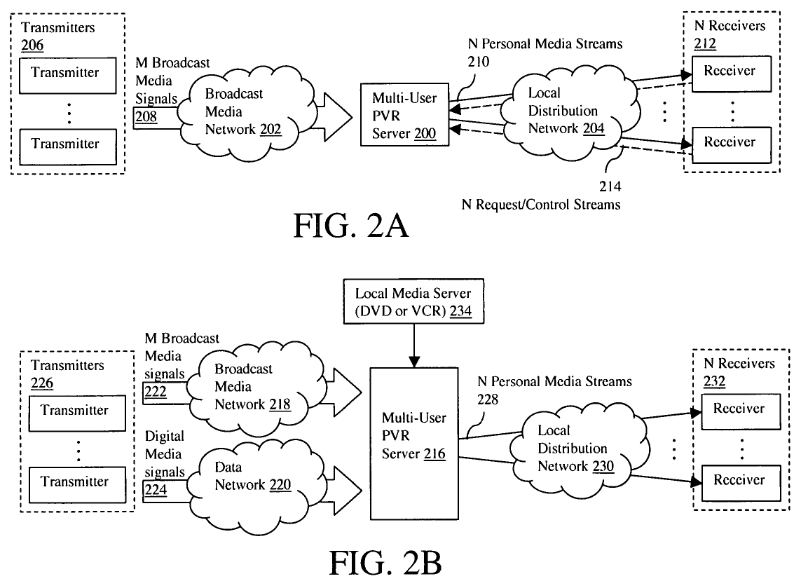

As illustrated in FIG. 2A, one embodiment of the present invention provides a multi-user PVR server device 200 located at an intermediate location between a broadcast media network 202 and a local distribution network 204. At the headed of broadcast network 202 is a plurality of transmitters 206 where M broadcast media signals 208 containing live or prerecorded broadcast audio and/or video media content. Signals 208 travel through network 202 and terminate at multi-user PVR server 200 which processes selected media signals and generates a plurality of N personalized media unicast streams 210. Server 200 transmits the N streams 210 over local media stream distribution network 204 to a corresponding plurality of N receivers 212 which present the media to end-users. The multi-user PVR server device 200 selectively receives one or more of the several broadcast media signals 208 available to the broadcast subscriber. The PVR server 200 can deliver any of the received signals to one or more end-user receivers 212. In mathematical terms, M broadcast streams are captured, personalized, and made available to N users. Each of the M streams can be personalized for each of the N users. This includes the case where different users could be watching distinct personalized streams derived from the same broadcast signal.

The receivers 212 may be various types of devices capable of receiving and rendering media streams (e.g., personal computers running client software, handheld wireless devices running client software, barebones set-top boxes with an attached television and an associated remote control element). Circuits and/or components in receiver 212 receive, decode and render the personalized media streams and present to each user an interface for making requests. For example, users may make requests for recording certain media content and/or to perform trick play functions. The trick play functions available to the end user may include pause, play, catch-up, instant replay, fast forward, rewind, and/or record. The recording requests may include channel, start time, end time or duration, and record quality, among other options. The requests are embedded in N user request/control streams 214 which are transmitted from the N receivers back to the server. Preferably, the request/control streams are transmitted over the local distribution network 204. Alternatively, streams 214 may be transmitted using a different communication network or channel. In one embodiment the control stream 214 is implemented over Real Time Streaming Protocol (RTSP). In another embodiment some adaptations to the standard RTSP protocol are implemented for the purpose of enabling PVR control on live streams. In one adaptation, the media locator string (RTSP URL) in the request transmitted in the control stream includes the media time. In yet another adaptation the media time is determined when requesting a live or stored stream and passed along in the Session Description Protocol (SDP) response within RTSP.

The PVR server 200 receives the request/control streams 214 and uses the request/control information to personalize streams 210. In some embodiments, the selection of the portion of broadcast media signals to be captured and stored at the PVR is determined in part by preferences specified by a system operator. In one embodiment the system includes software which can enable an operator to remotely connect to the system using a data network and specify preferences, e.g., to tune the PVR to record specific channels. In one embodiment, the selection of the content to be recorded and streamed is based on each user's personalization requests with respect to time and channel information.

At the PVR server 200 selected channels contained in the broadcast media signals 208 may be recorded to one or more storage devices, where the selection of the channels may be determined by one or more of a default server configuration, and/or one or more operator(s) and/or one or more user request(s). The selection of recording may be, for example, all the media signals for all the selected channels for a 24 hour period, or the unique sum of all the recording requests from all the receivers 212.

The PVR server 200 generates, as output, the plurality of unicast personalized media streams 210, which may be personalized in various ways including, for example, introducing user-specified time-shift operations on any of the live channels or any of the recorded media. The personalized streams 210 are transmitted from the server 200 over the local media distribution network 204 to the user receivers 212.

The multi-user PVR server device comprises a plurality of input processors that capture and encode selected portions of the incoming media signals into a format suitable for further downstream transmission to users. The PVR server also comprises one or more storage devices that selectively record the selected content. Preferably, the content is segmented into small, possibly consecutive, time-tagged chunks of media. Output processors in the PVR server read the appropriate sequence of chunks from the appropriate storage device(s) and generate personalized media streams 210 that are then transmitted over local distribution network 204 to the plurality of receivers 212. The local distribution network 214 may be any of various types of networks capable of distributing streaming media (e.g., an IP data network, a WiFi network, a two-way enabled MDU/MTU cable plant). In one embodiment, the local network 214 is an IP network and the personal media streams 210 are transmitted in the form of Real Time Protocol (RTP) packets using TCP/IP, where a unique stream of packets is transmitted to each receiver actively connected to the local distribution network.

In some embodiments, there may be multiple PVR servers like server 200 that are also connected to the subscriber end of broadcast media delivery network 202. Each of these servers serves personal media streams over a corresponding plurality of local distribution networks to receivers connected to those local networks, analogous to the distribution of streams 210 as described above. The present architecture is therefore scalable and allows a single PVR server 200 to service a multi-user collection of receivers such as a collection of receivers in an airport, hotel, hospital, apartment complex, MDU/MTU, public/private commercial establishment, or multi-TV residential environment. Other PVR servers connected to network 202 can also service additional multi-user environments. In addition, single-user receivers can connect directly to broadcast media network 202, as conventionally done in the past.

The broadcast network 202 may be, for example, a HFC cable network, satellite DBS network, terrestrial TV broadcast network, or a combination of these. Network 202 may be supplemented by one or more additional networks. For example, in the embodiment shown in FIG. 2B a multi-user PVR server 216 receives broadcast media signals 222 over a broadcast media network 218, just as in FIG. 2A. In addition, server 216 downloads selected digital media signals 224 over a broadband data network 220 such as the internet or back-end peer-to-peer network layer. Digital media signals 224 may be, for example, digital multimedia files such as video advertisements or video “blogs” that have been submitted for delivery during various time-slots as all or part of one or more media channels. This embodiment includes the case where a single hybrid network serves simultaneously as both a broadcast media network 218 and a data network 220.

Alternatively, or in addition, media may also be received and captured from a local media server 234, which may include, for example, DVD players, VCRs, and/or digital storage media such as hard disk drives. In any case, irrespective of its ultimate source(s), captured media content is stored in PVR server 216 and used to generate personalized media streams 228 which are sent over local distribution network 230 to the receivers 232, just as in FIG. 2A.

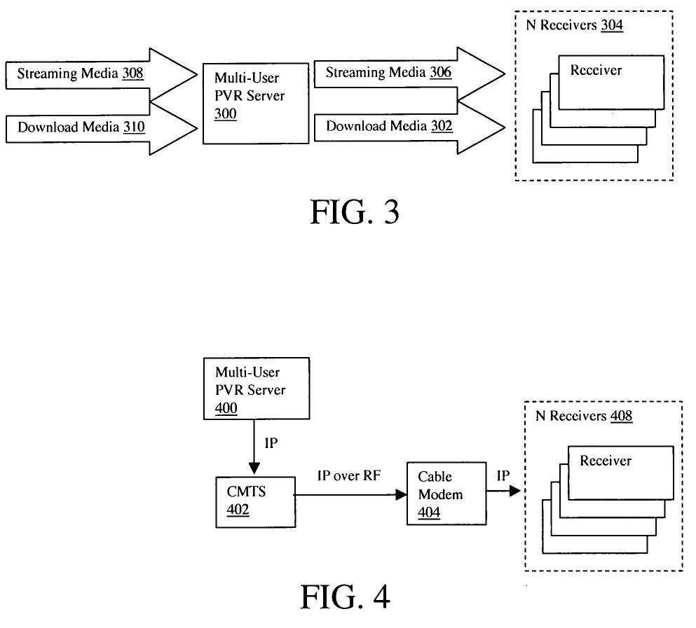

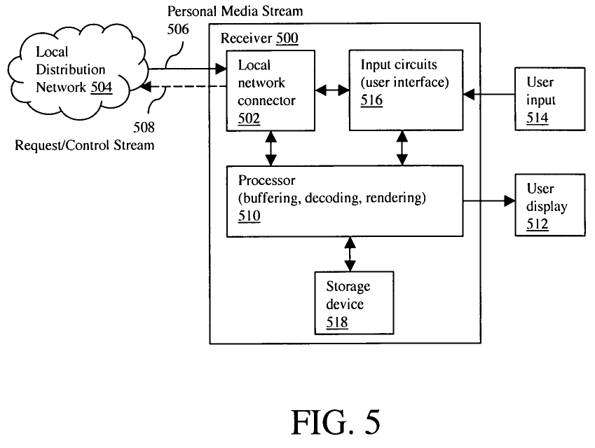

In another embodiment, the personalization includes both streaming media and non-streaming media, e.g., a time window of a broadcast media channel packaged as a single file for download from the PVR server to a user receiver device. FIG. 3 illustrates this embodiment wherein the media content at the PVR server 300 is packaged into a file and downloaded 302 onto one or more user receivers 304. The media content at PVR server 300 may also be delivered to receivers 304 as streaming media 306, as described earlier. In one implementation of this embodiment the media files selected by the user are downloaded to the receiver using HTTP. In another variation the media is a collection of media segments, which are packaged to provide a seamless experience to the end-user. Similarly, the media content delivered from the PVR server 300 to the receivers 304 may have been captured by the PVR server 300 as either streaming media 308 or download media 310.

In another embodiment the local distribution network is a wireless network such as UMTS or 3G cellular. In another embodiment the IP network operates over a wireless network such as an IEEE 802.11 “WiFi” network. In one embodiment the local distribution network is an IP network that operates over a wired infrastructure such as Category 5 wired Ethernet. In one embodiment, the local distribution network is a two-way capable coax cable network and the audio/video is directly modulated as individual channels for each end user. In another embodiment, the media is transferred to the end user using IP over coax methods, as shown in FIG. 4, the PVR server 400 sends personalized streaming media over IP to a Cable Modem Termination System (CMTS) 402, which modulates it over RF cable. The cable modem 404 demodulates it back to IP and the receivers 408 render the media to the multiple users. The CMTS/cable modem system may use multiple frequency ranges in order to increase the number of users that can be served. These frequencies may conflict with ranges that are conventionally reserved for broadcast cable TV transmission. The system may preferentially serve all users with personalized unicast streams without needing to reserve any bandwidth for broadcast service. In another embodiment, the users are provided access to the Internet along with the above described personalized media delivery over one common IP over cable infrastructure.

In one embodiment a user-end receiver 500 is has a local network connector 502 connected to the local distribution network 504. Connector 502 receives the personalized stream 506 from the PVR server and transmits user requests/control stream 508 back to the PVR server. Receiver 500 also contains a processor 510 that buffers, decodes and renders the incoming media stream to user display/output device 512 (e.g., TV) for the user to experience the media content. Input circuits 516 implement an input interface to receive requests and control signals from a user input device 514 (e.g., remote control) which enables a user to make media recording requests, trick play requests, channel change requests, etc. The receiver may also be provided with a storage device 518 that can be used to store downloaded media files for playback at a later time when the receiver may not be connected to the distribution network.

In one embodiment, the receiver 500 may be a computer with a network port 502 such as wired Ethernet or WiFi, a general-purpose processor 510 and storage 518, an attached monitor 512 and a keyboard and/or a mouse 514. The computer may be desktop computer or a portable device such as a laptop computer, personal media player, or portable multi-function device combining such functions as a personal data assistant (PDA) and a cell phone.

In one embodiment the processor 510 executes a software client program which includes a media player, e.g., an ActiveX control within a web browser. The client software may be automatically transmitted over local network 504 from the PVR server to the receiver 500 at the start of a session. The client software may be renewed as needed over time, such renewal resulting in the transmission of all or part of the new client software at the start of a subsequent session. In other embodiments, a general purpose client program can be installed on any receiver device 500 capable of decoding and rendering the media. The client software enables the receiver to receive live media streams 506 and send back request/control streams 508 using a variety of methods which include RTSP, HTTP as well Unix pipes.

In some embodiments, parts or all of the processor 510 may be implemented in hardware and/or firmware. In one embodiment, the processor 510 comprises an IP-to-TV decoder which converts an incoming IP stream 506 to a standard TV format such as NTSC/PAL which is sent to the attached TV 512 over standard audio/video connections such as Composite Video, S-Video, or Stereo Audio. User input device 514 may include an Infrared remote control, wired or wireless keyboard, and/or wired or wireless mouse.

User requests embedded in request/control stream 508 may include, for example, functions such as media play, pause, replay, channel changes, program guide display and/or navigation, recording selection/scheduling, and others.

In one embodiment, if the end-user device 500 does not receive media stream 506 for a duration lasting longer than a minimum threshold (e.g., two seconds) after its media buffers are empty it may issue a request to the PVR server via request/control stream 508 for a fresh stream 506. The fresh stream may include an extra portion of media, e.g., an extra three seconds of media. This rebuffering technique may be implemented using an exponential back off scheme where the time intervals between rebuffering events is exponentially increased to avoid flooding the network 504.

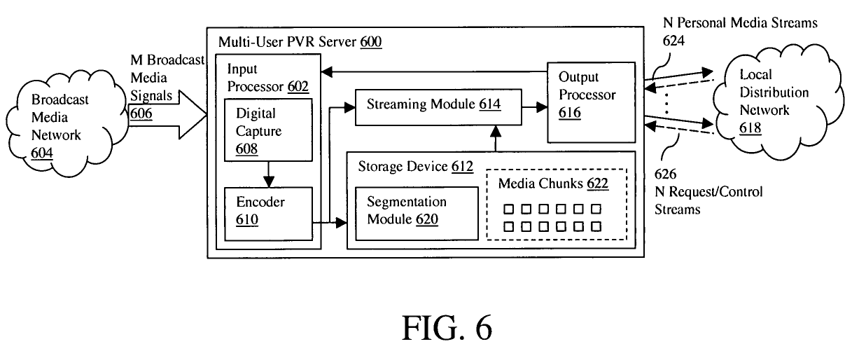

A multi-user PVR server 600 according to one embodiment of the invention is illustrated in FIG. 6. The server has an input processor 602 connected to broadcast media network 604 for receiving broadcast media signals 606. Input processor 602 has a digital capture module 608 that captures the audio/video frames of a selected portion of media signals 606 and an encoder 610 that encodes the captured media for secure storage and/or transmission. The captured and encoded media content is sent to storage device 612 for future use. In addition, or alternatively, the encoded media content may be simultaneously sent to a streaming module 614 and output processor 616 for immediate transmission of live media streams 624 over the local distribution network 618 to end-users. Processor 616 also receives request/control streams over the local network 618 from end-users.

Input processor 602 is preferably programmed to select specific portions of the broadcast media signals in accordance with adjustable preferences and/or requests. The selected portions may include, for example, selected channels and selected time periods. Input processor 602 may also aggregate or buffer captured and encoded media for a pre-determined time (e.g., 1 second) before sending the captured and encoded media to the storage device 612 and/or to the streaming module 614.

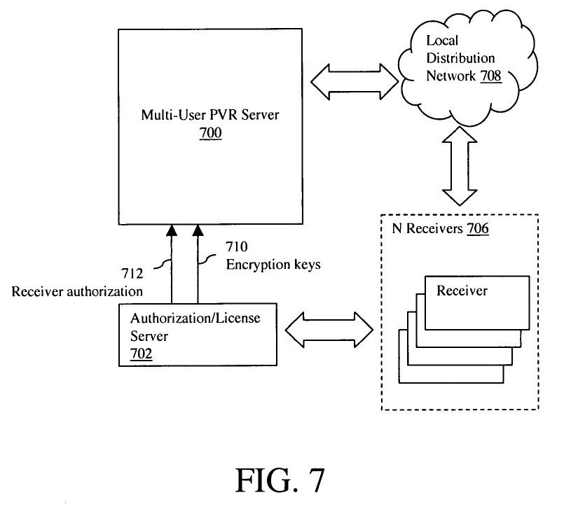

Encoder 610 may perform data compression as part of, or in addition to, encoding. For example, the media may use a compressed encoding format such as, for example, ISO-MPEG4 or H.264. The specific encoding scheme used may adapted in real time to the amount of bandwidth available to distribute the stream to end-users. In addition, the encoding scheme is preferably a format such that the potential end-user devices have the capability to decode the stream. Encoder 610 may also perform additional functions such as encryption to protect the media. For example, the media stream may be encrypted using 256-bit AES encryption. In on implementation, each media frame is encrypted and encapsulated with a header which includes the encryption key identifier, the amount of padding, the initialization vector, the checksum to verify the integrity and a sequence number used to prevent replay attacks. The encryption keys 710 may be acquired by PVR server 700 within a license issued from an authorization or license server 702, as shown in FIG. 7. In one embodiment, the keys 710 are acquired at the time the PVR server 700 first starts up and then updated at frequent intervals over time.

Returning now to the discussion of PVR server 600 in FIG. 6, the captured and encoded media is sent from input processor 602 to storage device 612 from which it may be retrieved subsequently by streaming module 614 to generate one or more personalized media streams 624 transmitted by output processor 616 over local distribution network 618. In one embodiment, the encoded media is sent to storage device 612 first and forwarded to the streaming module 614 for live transmission. The encoded media saved in storage device 612 may be retrieved and sent to streaming module 614 in response to time-shifted and/or personalized media requests from users.

In a preferred embodiment, media storage device 612 uses a chunk-based storage scheme and a storage medium, which provides random access, buffered I/O. A segmentation module 620 segments the media into media chunks 622 and labels each media chunk with a start time of the media. In one implementation, for example, the chunks are one minute long media files that are labeled by including within the file name a channel and time code, such as CH_HHMM, where CH corresponds to the media channel, HH corresponds to the hour, MM corresponds to the minute.

Segmentation module 620 also maintains a media chunk index which points to the location of the chunks within the storage medium. The storage medium may be, for example, a digital file system and the chunk index may be the directory and file indexing system available within the file system. The size or duration of each media chunk may be adaptively selected by the segmentation module 620 based on the indexing capacity of the storage media. As the indexing capacity increases, the chunks can get smaller. For example, if a standard Unix file system is used for storage, the chunk size (CS) may be calculated from the maximum number of nodes (N) in a directory and the time period for which media is to be stored (T hours) using a formula such as CS=Tx60/N. If a calculated chunk size will result in large seek times within the chunk when users request media for a given time within the chunk, the value of T for a given directory may be reduced. The period T is divided into smaller time segments (TS) and each time segment is mapped to a directory using a directory-naming scheme. For example, all media for the hour 23:00-23:59 is stored in a directory labeled “23”. This technique enables an innovative streaming architecture which can operate without knowledge of either the codec or the container used to encode the media. In other words, it provides a Codec-Container agnostic streaming architecture.

When media is retrieved from the storage device 612 by streaming module 614 the chunk index may be used to identify the chunk corresponding to a requested media start time. If the requested start time is at an intermediate time within the chunk, a disk reader process reads the chunk sequentially to locate the requested start time within the chunk. The chunk-based scheme and the use of a random access, buffered I/O storage medium provides the system with high-performance multi-user PVR functionality.

The storage device 612 could comprise a single storage medium or multiple storage media distributed over several physical or logical file systems. In a distributed file system the file may be referenced by name and the file system transparently identifies the appropriate physical storage medium. Thus the logical addressing scheme of a file system is used to transparently manage access to media, which is distributed across several physical storage devices.

In one embodiment, the streaming module 614 retrieves media files from storage device 612 and generates media streams which the output processor 616 transmits over the local distribution network 618 to multiple receivers. Alternatively, or in addition, media files may be directly downloaded through output processor 616 and local network 618 to receivers (i.e., without streaming).

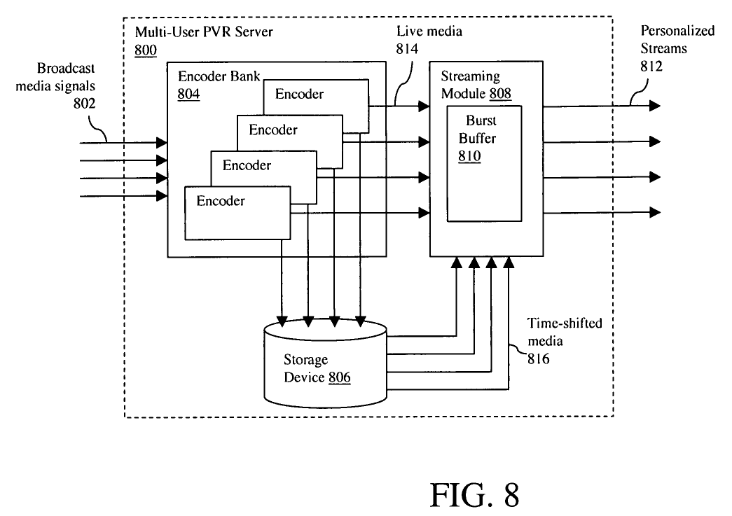

FIG. 8 illustrates aspects of a multi-user PVR server 800 providing the users with live feeds within minimal delays, while at the same time providing users with full PVR functionality on the live feeds. The PVR server 800 receives and captures selected broadcast media signals 802. Captured media signals enter an encoding bank 804 where separate selected media channels are encoded in parallel by a corresponding collection of separate encoders. The live encoded media 814 from each encoder is simultaneously sent to both storage device 806 and streaming module 808. The streaming module 808 uses the live media 814 coming from the encoders to generate personalized live media streams 812 for users requesting live feeds. For users requesting time-shifted feeds, the streaming module 808 retrieves time-shifted media 816 from storage device 806 to generate personalized time-shifted streams 812. In one implementation the streaming module 808 requests media frames from a reader process which reads media from storage device 806 and sends the frames to the streaming module. In another implementation the streaming module 808 directly reads the frames from the storage device 806. In another embodiment, the streaming module 808 uses a design which enables fast channel switching to enhance the user experience. The streaming module 808 contains a burst buffer 810 and implements a burst logic which sends out on one of the personalized streams 812 an initial burst of media frames whenever the corresponding user switches a channel or uses trick-play controls on the current channel. In one implementation the streaming module 808 waits until it has a predetermined amount of media (e.g., three seconds of media) stored in the buffer 810 and then sends the entire buffered media content in a burst to the end-user device over one of the personalized streams 812. This functionality is preferably coupled with a synchronized buffer element at the receiver. For example, the synchronized buffer on the end-user device may be managed so that it always has at least three seconds of extra media. This technique ensures that the media will play continuously even if there is a transient problem in the distribution, e.g., if the end-user device does not receive media for two seconds.

One embodiment of the invention includes a Media Gap Management technique to enable pause/replay of live broadcast media and to seamlessly handle gaps in the stored media. This technique can be described with reference to FIG. 6 as follows. In response to a specific media request sent over one of the request/control streams 626 from a receiver to the PVR server 600, the streaming module 614 sends to the requesting receiver a media start time for the media requested. This start time may later be used to determine the media offset to be used in response to any subsequent pause/play/replay/catch-up requests. In one implementation, the media start time is returned in a Session Description Protocol (SDP) data sent from the multi-user PVR server to the receiver as part of one of the personalized media streams 624. This start time is the media time that corresponds to the live or stored media as the case may be. The use of SDP for both stored and live media simplifies the play/pause/replay logic within the player.

In one implementation the streaming module 614 stops sending a stream 624 when it discovers a gap in the stored media being used to generate the stream. This causes the receiver of the stream to issue a fresh request to the PVR server 600 for the media. The request contains the media time corresponding to where the gap was found. The streaming module 614 checks to see if the requested media is available and sends to the receiver the media time of the next available media. Thus, if there are gaps in the media, the streaming module “jumps” the gap. The receiver stores the media time returned by the streaming module. This media time is used to compute any media offsets that are requested by the receiver in response to pause/play/catch-up/replay commands. This technique is preferably used with a rebuffering scheme where it issues a fresh request for the media whenever it finds that it is no longer getting data for a requested media stream.

In another embodiment the streaming module 614 is a combination of an RTP server and a relay server. The RTP server uses UDP to send the frames to the relay server. The relay server can then send the frames over UDP or TCP or multicast depending on the connectivity of the receiver. This implementation provides greater flexibility in delivering the media to the player without impacting the core encoding and frame generation functionality. It also provides a path to scaling the distribution of the media across several relays. The RTP server could use multicast to send the frame simultaneously to several relay servers, which are connected on a multicast enabled network. The relay server can then distribute the frames to several users over networks that do not support multicast or networks that are not suitable for delivery of UDP/multicast packets such as an 802.11 network.

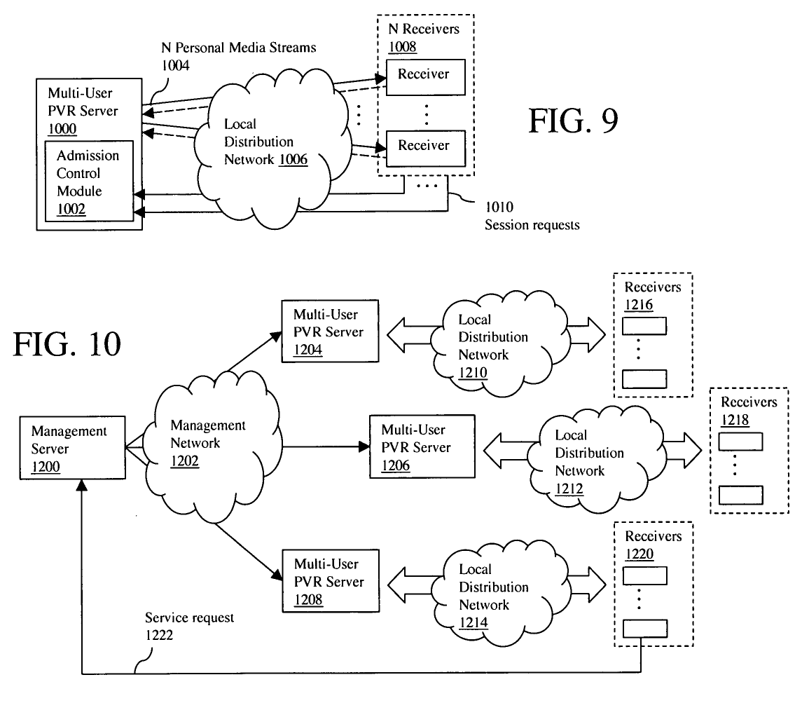

In another embodiment an admission control technique is used to decide if the local distribution network has the resources available to deliver the media. As illustrated in FIG. 9, a PVR server 1000 is provided with an admission control module 1002. The receivers 1008 send session requests 1010 to admission control module 1002 in PVR server 1000 and are assigned a session from the admission control module 1002 before receiving personal media streams 1004 over local distribution network 1006. The admission control module 1002 checks if the distribution network 1006 has the resources available to provide requested media to the user. The set of resources includes but is not limited to the bandwidth available in the distribution network 1006. In another implementation the PVR server 1000 is aware of the total bandwidth available in the distribution network 1006 and the bandwidth required per user. The admission control module 1002 reserves the bandwidth for a user before allowing the user session to start. If the reservation fails the media server 1000 does not provide a personal media stream to the user. In one implementation the distribution network 1006 is a WiFi network and the admission control is performed using the HTTP protocol. The server identifies the 802.11 access point that the user is connected to. The server keeps track of the bandwidth available at this access point based on users currently connected through this access point. The device can make a decision of whether there is bandwidth available to support a new session to a user device. In another embodiment the server checks with an access point controller to determine the access point that the user is connected to. In another embodiment the server works in conjunction with the receiver to identify the 802.11 access point that the user is connected to. The receiver finds out the identity of the access point that it is connected to and notifies the server.

In another embodiment an authorization technique is used to determine whether a user can receive requested media and/or be admitted. FIG. 7 illustrates an embodiment wherein the multi-user PVR server 700 is designed to receive authorization 712 from external authorization server 702. The authorization 712 includes but is not limited to the level of access granted to the receiver, which in turn decides the set of media that the receiver is allowed to access. The receiver requesting media from the multi-user PVR server 700 is notified of the need to get an authorization. The receiver then communicates with the authorization server 702, which issues an authorization 712 to the multi-user PVR server. In one implementation of this embodiment the authorization server 702 is a web server on the Internet checks the user credentials and issues a signed authorization. The authorization is forwarded to the multi-user PVR server 700 using an HTTP redirect request. The multi-user PVR server verifies the signature and accepts the authorization. In another implementation the authorization server 702 is a web based payment server on the Internet, which receives a credit card payment and issues an authorization. In another implementation the authorization server 702 accepts a third party user account as a billing entity and interfaces within the necessary third party entities to authorize the payment. The use of standards based mechanisms available within HTTP and Public Key Infrastructure (PKI) ensures maximum flexibility in the implementation of the individual admission control, authorization and delivery. This further facilitates the seamless addition of introduction of third party authorization entities, which in turn use well-defined standards-based mechanisms to integrate into the system. Authorization server 702 may also serve as a license server providing cryptographic keys to the PVR server 700, as described earlier, and/or to one or more receivers 706.

In another embodiment illustrated in FIG. 10, a centralized management server 1200 controls several multi-user PVR servers 1204, 1206, 1208 to facilitate the roll out and administration of a managed multi-user PVR service. The multi-user PVR servers 1204, 1206, 1208 are connected to a common management server 1200 over a management network 1202. The PVR servers 1204, 1206, 1208 are connected to corresponding sets of receivers 1216, 1218, 1220 via respective local distribution networks 1210, 1212, 1214.

Each PVR server bootstraps a secure channel with the management server 1200 and receives its programming information and/or encryption key information over this secure channel. In one implementation of this embodiment, the bootstrapping process involves a signed identity file issued by the management server 1200 for a multi-user PVR server. This file is presented as identification by the multi-user PVR server to the management server. In one implementation the multi-user PVR server generates a private-public key pair and sends the public key to the management server. All future communications can now be secured using this set of keys. In another implementation the secure channel is an HTTPS channel wherein the bootstrapping process sets up the private and public keys of the multi-user PVR. In another implementation the secure channel is used to transfer logs including billing data from the multi-user PVR server to the management server.

In another embodiment, the management server 1200 maintains a network map of the location of several PVR servers. A receiver can directly connect to the management server 1200 at a well known location on the network and send a service request 1222. The server 1200 redirects the receiver to a local PVR server 1208, which is closer to the receiver. The receiver can then receive media from the local PVR server 1208. In another embodiment the management server 1200 is identified by a name and can be accessed over the Internet at a web address. In another embodiment the individual receiver devices connect to the management server and notify the management server of their network location, e.g., an IP address or a combination of IP address and subnet. The network location may also be derived from the properties of the network connection between the PVR server and the management server.

In another embodiment, each PVR server automatically finds the management server, thus enabling the management server to redirect users to an appropriate local PVR server. This significantly simplifies the installation and discovery of the local PVR server.

In another embodiment, the PVR server is connected to a private IP network, which provides DHCP and Internet connectivity. The PVR server connects to the management server using a web server name configured on the PVR server. The server name is configured as part of the factory install of the box. The person installing the PVR server has the flexibility of changing or configuring the web server name. The PVR server appears to be connecting from an address determined by the gateway of its private network. A user on the private network also connects using the same gateway and hence appears to be connecting from the same address. The centralized server is able to correlate the two connections and redirect the user to the local PVR server

In another embodiment the encryption key generation is centrally coordinated and the keys are distributed to several PVR servers. Users connecting to any one of the PVR servers can then connect to a known management server to obtain a license.

In another embodiment the multi-user PVR servers are monitored using a combination of alerts that are generated with the PVR servers are able to contact the management server. The management server is also programmed to generate alarms in the event of a designated multi-user PVR server failing to contact the management server. This provides a degree of pre-emptive fault management not available in existing media server systems.

Following is a description of the operation of a PVR server system in accordance with an embodiment of the present invention.

Step 1: Referring to FIG. 10, a PVR server 1208 communicates with the management server 1200 to receive its programming information.

Step 2: The server 1208 communicates with the central management server 1200 to receive current media encryption keys, which may be updated at regular intervals.

Step 3: Now referring to FIG. 8, each of the encoders in the bank of encoders 804 receives a media feed by reading frames from physical encoder cards embedded in the system.

Step 4: The frames are encrypted and relayed to the streaming module 808. The encoder and the streaming module use shared memory to relay of the encoded and encrypted frames.

Step 5: The encoders 804 simultaneously write the frames to the disk 806.

Step 6: Referring now to FIG. 2A, one of the end-user receivers 212 connects to the server 200 and receives a session, a player, and programming information in the form of a user interface. For example, the interface may be comprised of an ActiveX control, JavaScript and flash action script and HTML. The user receives a session if there are network resources available to stream media to the user via local network 204.

Step 7: The user makes a selection in the user interface, the player communicates with the server 200 to request the media using RTSP 214.

Step 8: Referring again to FIG. 10, when the server 1208 receives the first request, it notifies the user interface to get the session authorized by the central authorization server 1200.

Step 9: The receiver is connected to the central server 1200 and asked to enter authentication information or payment information. Once the authorization is complete, an authorization payload is returned. The player also receives a license, which enables it to decrypt the media sent by the server 1208.

Step 10: The authorization payload is sent to the server 1208 using an HTTP redirect mechanism. The server receives the authorization and flags the session to be authorized.

Step 11: Referring now to FIG. 6, the streaming module 614 in the server 600 receives requests and returns a SDP payload within the RTSP connection, which describes the characteristics of the media to be sent to the user over one of the personalized streams 624. These characteristics include the media time corresponding to the requested media, which will be used to provide pause/play/replay and catch-up functionality.

Step 12: The player sets up receivers for the media streams described in the SDP payload and issues a “start playing” request to the server using standards RTSP protocol commands.

Step 13: The streaming module 614 adds the player to the list of receivers for the media stream and keeps track of the amount of media streamed to the user. The streaming module preferably ensures that the buffer in the player receives an initial burst of at least three seconds of media and subsequently ensures that the buffer in the player always has the extra three seconds of media.

Step 14: If the user hits pause/replay and thus wants to receive stored content, the player makes a new RTSP request to the streaming module 614 over one of the request/control streams 626 with the appropriate media time computed based on the media time returned in the SDP payload and the amount of media that the user has played through.

Step 15: The streaming module 614 accesses storage device 612 which uses chunk-based storage and indexing to index into the stored media. Module 614 starts sending the requested media stream over local network 618 to the player.

Although various embodiments of the present invention and its advantages have been described above in detail, it should be understood that the present invention is not limited to or defined by what is shown or discussed herein. In particular, drawings, tables, and description disclosed herein illustrate technologies related to the invention, show examples of various aspects of the invention, and provide examples of using specific embodiment of the invention and are not to be construed as limiting the present invention. Known methods, techniques, or systems may be discussed without giving details, so to avoid obscuring the principles of the invention. As it will be appreciated by one of ordinary skill in the art, the present invention can be implemented, modified, or otherwise altered without departing from the principles and spirit of the present invention.

1. A multi-user personalized multimedia distribution method comprising:
broadcasting over a media broadcast network a plurality of media signals from a plurality of network transmitters located at a head end of the media broadcast network;
receiving and storing the plurality of media signals at a multi-user media server located at a terminal point of the media broadcast network;
generating from the plurality of media signals a plurality of corresponding personalized unicast media streams independently customized using a plurality of stored personalization preferences; and
transmitting the plurality of personalized media streams from the multi-user media server over a media stream distribution network to a corresponding plurality of end user devices associated with the stored personalization preferences.

2. The method of claim 1 wherein receiving and storing the plurality of media signals at the multi-user media server comprises selectively recording live broadcast channels as determined by the plurality of stored personalization preferences.

3. The method of claim 1 wherein receiving and storing the plurality of media signals at the multi-user media server comprises selectively recording live broadcast channels as determined by system administrator control signals transmitted from a remote location to the multi-user media server.

4. The method of claim 1 wherein the stored personalization preferences are specified at least in part by an entity selected from the group consisting of an end user and a system operator.

5. The method of claim 1 wherein transmitting the plurality of personalized media streams is responsive to media requests transmitted from the end user devices to the multi-user media server.

6. The method of claim 1 wherein each of the plurality of personalized media streams may be independently time-shifted.

7. The method of claim 1 further comprising providing an end user device with a user interface presenting user options for controlling and customizing a corresponding unicast media stream, generating a media control stream in response to a selected user option, and transmitting the media control stream from the end user device to the multi-user media server.

8. The method of claim 7 wherein generating the plurality of personalized media streams comprises introducing a media time shift operations on the corresponding unicast media streams in accordance with the media control stream.

9. The method of claim 1 wherein transmitting the media control stream is implemented using RTSP or a variant thereof.

10. The method of claim 1 wherein receiving and storing the plurality of media signals comprises segmenting each of the media signals into separate media chunks, time-tagging each media chunk with a unique time tag identifying a start time of the media chunk, and storing the separate media chunks.

11. The method of claim 10 wherein segmenting each of the media signals into separate media chunks uses a chunk size selected based on an indexing capacity of a storage device used to store the media chunks.

12. The method of claim 10 wherein the media signals are encoded media signals and wherein the segmenting is performed without decoding the encoded media signals.

13. The method of claim 1 wherein receiving and storing the plurality of media signals at the multi-user media server comprises storing the plurality of media signals on a distributed data storage system.

14. The method of claim 1 wherein receiving and storing the plurality of media signals comprises updating a media chunk index.

15. The method of claim 1 further comprising generating at an end user device a request for a fresh stream from the multi-user media server in response to an empty stream buffer state lasting longer than a predetermined minimum threshold.

16. The method of claim 1 further comprising restarting a unicast stream and resetting a media start time at the multi-user media server in response to a gap in a media signal lasting longer than a predetermined threshold.

17. The method of claim 1 further comprising generating at the multi-user media server a fresh unicast stream in response to a request by an end user device, wherein the fresh stream comprises an additional buffer portion of the media stream.

18. The method of claim 1 further comprising generating a the multi-user media server an initial unicast media stream burst in response to receiving a request from an end user to change media channels.

19. The method of claim 1 further comprising generating at the multi-user media server an initial unicast media stream burst in response to receiving a trick-play control request from an end user.

20. The method of claim 1 further comprising transmitting over a back-end peer-to-peer network layer an on-demand media signal from a network transmitter located at a head end of the media network.

21. The method of claim 1 wherein the media signals comprise a media selected from the group consisting of broadcast media, on-demand prerecorded media, advertisements, video blogs, audiovisual media, and audio media.

22. The method of claim 1 wherein the media broadcast network comprises a network selected from the group consisting of a cable media network, a satellite media network, a wireless television broadcast network, and a video storage playback device.

23. The method of claim 1 wherein transmitting the plurality of personalized media streams comprises embedding the media streams in RTP packets and transmitting the RTP packets using TCP/IP.

24. The method of claim 1 wherein the media stream distribution network comprises a network selected from the group consisting of an IP network, a wifi network, and a two-way enabled multi-dwelling unit cable plant.

25. The method of claim 1 wherein the end user device is a device selected from the group consisting of a desktop computer, a laptop computer, a hand-held computer, and a set-top box coupled with a television.

26. The method of claim 1 wherein receiving and storing the plurality of media signals at the multi-user media server comprises encrypting the media signals for secure storage.

27. The method of claim 1 wherein independently generating a plurality of personalized unicast media streams comprises encrypting each of the personalized unicast media streams using an encryption key specific to each unicast media stream.

28. The method of claim 1 further comprising performing an authorization check to authorize a user device to receive a specified media content.

29. The method of claim 1 further comprising providing a management server in secure communication with multiple multi-user media servers, wherein the management server provides one of the multi-user media servers with one or more media encryption keys.

30. The method of claim 29 wherein the management server performs an authorization check to authorize a user device to receive a specified media content.

31. The method of claim 29 wherein the management server maintains a network map of multiple multi-user media servers and assigns user devices to multi-user media servers.

32. The method of claim 29 wherein the management server transparently connects a user device to a multi-user media server capable of delivering a unicast stream to the user device at a required quality level.

33. A multi-user personalized multimedia distribution system comprising:
a media broadcast network,
a plurality of network transmitters located at a head end of the media broadcast network,
a multi-user media server located at a terminal point of the media broadcast network,
a media stream distribution network connected to the multi-user media server, and
a plurality of end user devices connected to the media stream distribution network;
wherein the multi-user media server comprises:
an input processor for receiving from the media broadcast network a plurality of media signals transmitted from the plurality of network transmitters;
a storage device for storing the plurality of media signals;
a streaming module for generating from the plurality of media signals a plurality of corresponding personalized unicast media streams independently customized using a plurality of stored personalization preferences; and
an output processor for transmitting the personalized unicast streams over the media stream distribution network to the plurality of end user devices.

34. The system of claim 33 wherein an end user device comprises a user interface presenting user options for controlling and customizing a corresponding unicast media stream, a network interface for transmitting from the end user device to the multi-user media server a media control stream in response to a selected user option. Wherein the unicast media streams are time-shifted in accordance with requests contained in the media control stream.

35. The system of claim 33 wherein the multi-user media server comprises a segmentation module for segmenting each of the media signals into separate media chunks and time-tagging each media chunk with a unique time tag identifying a start time of the media chunk, and wherein the storage device stores the media signals in the form of separate media chunks.

36. The system of claim 33 wherein media chunks have a chunk size selected based on an indexing capacity of the storage device.

37. The system of claim 33 wherein the storage device is a distributed data storage system.

38. The system of claim 33 wherein the media broadcast network comprises a network selected from the group consisting of a cable media network, a satellite media network, a wireless television broadcast network, and a video storage playback device.

39. The system of claim 33 wherein the media stream distribution network comprises a network selected from the group consisting of an IP network, a wifi network, and a two-way enabled multi-dwelling unit cable plant.

40. The system of claim 33 wherein the end user device is a device selected from the group consisting of a desktop computer, a laptop computer, a hand-held computer, and a set-top box coupled with a television.

41. The system of claim 33 wherein the multi-user media server comprises an encoder for encrypting the media signals prior to storage.

42. The system of claim 33 further comprising an authorization server for performing an authorization check to authorize a user device to receive a specified media content from the multi-user media server.

43. The system of claim 33 further comprising multiple multi-user media servers and a management server in secure communication with the multiple multi-user media servers.

44. The system of claim 43 wherein the management server provides the multi-user media server with one or more media encryption keys.

45. The system of claim 43 wherein the management server maintains a network map of multiple multi-user media servers and assigns user devices to multi-user media servers.

46. The system of claim 43 wherein the management server transparently connects a user device to a multi-user media server capable of delivering a unicast stream to the user device at a required quality level.

47. A multi-user media server comprising:
an input processor for receiving from a media broadcast network a plurality of media signals transmitted from a plurality of network transmitters;
a storage device for storing the plurality of media signals;
a streaming module for generating from the plurality of media signals a plurality of corresponding personalized unicast media streams independently customized using a plurality of stored personalization preferences; and
an output processor for transmitting the personalized unicast streams over a media stream distribution network to a plurality of end user devices.

48. The server of claim 47 wherein the input processor selectively receives live broadcast channels as determined by the plurality of stored personalization preferences.

49. The server of claim 47 wherein the input processor selectively receives live broadcast channels as determined by system administrator control signals transmitted from a remote location to the multi-user media server.

50. The server of claim 47 wherein the stored personalization preferences are specified at least in part by an end user.

51. The server of claim 47 wherein the stored personalization preferences are specified at least in part by a system operator.

52. The server of claim 47 wherein each of the plurality of personalized media streams may be independently time-shifted.

53. The server of claim 47 further comprising a segmentation module for segmenting each of the media signals into separate media chunks and time-tagging each media chunk with a unique time tag identifying a start time of the media chunk, and wherein the storage device stores the media signals in the form of separate media chunks.

54. The server of claim 47 wherein media chunks have a chunk size selected based on an indexing capacity of the storage device.

55. The server of claim 47 wherein the media signals are encoded media signals and wherein the encoded media signals are segmented into separate encoded media chunks without decoding.

56. The server of claim 47 wherein the storage device is a distributed data storage system.

57. The server of claim 47 further comprising an encoder for encrypting the media signals prior to storage.
